(19) United States
(12) Patent Application Publication
(10) Pub. No.: US 2004/0177109 A1
(43) Pub. Date: Sep. 9, 2004

(54) Method of providing automatic connection service for taxis using communication network

(76) Inventor: Jae-Wook Lee, Busan (KR)

Correspondence Address: Mark Friedman, Bill Polkinghorn, Discovery Dispatch, 9003 Florin Way, Upper Marlboro, MD, 20772, US

(21) Appl. No.: 10/479,956

(22) PCT Filed: Jun. 18, 2002
(86) PCT No.: PCT/KR02/01143

(30) Foreign Application Priority Data
Jun. 18, 2001 (KR) 2001/34505
Jul. 26, 2001 (KR) 2001/45255

(51) Int. Cl. G06F 15/16

(52) U.S. Cl. 709/201

(57) ABSTRACT

Disclosed herein is the present invention relates generally to a method of providing an automatic connection service for taxis using a communication network, and more particularly to a method of providing an automatic connection service for taxis using a communication network, in which a client can call a taxi using his mobile phone through a communication network without the client personally ascertaining his position and informing a taxi call service provider his position, a central control office ascertains a client's position and transmits information of an available taxi closest to the client's position to the client by the client accessing the central control office of the taxi call service provider, and the client selects and calls the available taxi, thus enabling the client automatically connect to a selectable taxi.

### TECHNICAL FIELD

The present invention relates generally to a method of providing an automatic connection service for taxis using a communication network, and more particularly to a method of providing an automatic connection service for taxis using a communication network, in which a client can call a taxi through a communication network using his mobile phone without the client personally ascertaining his position and informing a taxi call service provider of his position, a central control office ascertains the client's position and transmits information of an available taxi closest to the client's position to the client while the client accesses the central control office of the taxi call service provider, and the client selects and calls the available taxi, thus enabling the client to automatically connect to a selectable taxi.

### BACKGROUND ART

Services for connecting a client to a call taxi through a phone call between the client and the driver of an available taxi are disclosed in Korean Patent Application No. 1999-45964 (Korean Non-examined Patent Publication No. 2001-38106) filed on Oct. 22, 1999. In this patent, when a client accesses a taxi call service provider using a mobile communication system, the taxi call service provider tracks the location of the client by ascertaining the call's originating location of the mobile phone of the client by the cell through a connection exchange, searches for available taxis within a cell where the client exists on the basis of the call's originating location, informs a corresponding available taxi of the client's mobile phone number, and allows the client to be connected to the driver of the corresponding available taxi. The service is advantageous in that the client does not need to directly enter his own location and provide the location to the taxi call service provider. However, the services are disadvantageous in that a client has to speak with the taxi driver by a mobile phone, the operator of the service has to explain the location of the client to the taxi driver and the taxi driver has to find the client based on his geographical knowledge, and the client is reluctant to use the taxi because the client can not know when the taxi will arrive or what kind of taxi will arrive.

### DISCLOSURE OF THE INVENTION

Accordingly, in order to solve the client's inconvenience and the above problem according to the operation of a taxi call service occurring in the prior art, an object of the present invention is to provide a method of providing an automatic connection service for taxis using the wireless Internet function of an mobile communication terminal and a car navigation system installed on a taxi, which allows a client to selectively call one of various taxis within a desired region in such a way that the method automatically tracks the location of the client, searches for an available taxi within a search radius corresponding to the requested conditions of the client on the basis of the tracked information, transmits map information in which the location information of the client is indicated to the searched available taxi, and provides the client with the information of the available taxi, thus improving the quality of taxi call services using a communication terminal such as a mobile communication terminal and the like, increasing the convenience of users, preventing traffic congestion caused by vacant taxis moving to pick up passengers, and increasing the efficiency of taxi business through the saving of fuel and so on.

In order to accomplish the above object, the present invention provides a method of providing an automatic connection service for taxis using a communication network comprising the steps of: a client who desires to use a taxi accessing a central control office through his own mobile communication terminal; the central control office tracking the location of the client by running its internal client location tracking database installed therein to ascertain the location information of the client; the central control office storing an ascertained client information; the central control office ascertaining service states of taxis under the control of the central control office, selecting an available taxi closest to the location of the client, and transmitting the location information of the client to a car navigation system of the selected available taxi; the car navigation system of the available taxi that received the location information of the client from the central control office displaying map information in which the location information of the client is indicated on a display device of the car navigation system; a driver of the available taxi checking the location of the client, determining whether he can reach the location of the client by considering current travel conditions such as the current state of his taxi, and informing the central control office of the determination result; if receiving an approval signal, which indicates that it is possible to reach the location of the client, from the available taxi, the central control office calculating an optimal route to the location of the client, and tracking, ascertaining and storing a predicted arrival time and taxi information to identify the available taxi which the client has called, such as the color and number of the available taxi, extracting a phone number of the client from the stored client information, and transmitting taxi information of the available taxi to the client terminal; and the available taxi that received the client information from the central control office moving to the location of the client.

In addition, the present invention provides a method of providing an automatic connection service for taxis using a communication network comprising the steps of: a client who desires to use a taxi accessing a central control office through his own mobile communication terminal; the central control office tracking the location of the client by running its internal client location tracking database installed therein to ascertain the location information of the client; the central control office storing an ascertained client information; if the location of the client is ascertained, the central control office ascertaining service states of taxis under the control of the central control office, and searching for an available taxi within ascertain search radius; the central control office transmitting a map page on which the location information of the searched available taxi within the certain search radius is displayed and taxi information of the available taxi within the certain search radius such as the type and number of the available taxi to the client terminal; the client that received the location information of the available taxi from the central control office selecting the available taxi displayed in the client terminal; the client transmitting the taxi information of the selected available taxi to the central control office; the central control office transmitting the location information of the client to the available taxi selected by the client; and a driver of the available taxi that received the location information of the client moving to the location of the client.

In addition, the present invention provides a method of providing an automatic connection service for taxis using a communication network comprising the steps of: a client who desires to use a taxi accessing a central control office by executing an Internet Web browser through his own mobile communication terminal; if receiving a call signal of the client, the central control office transmitting a page to allow the client to determine whether he requires the central control office to search for an available taxi within a certain search radius from the current location of the client or a search radius desired by the client; the client entering his own request conditions to the page transmitted from the central control office and transmitting the entered request conditions to the central control office; if the client requires the central control office to search for an available taxi within the certain search radius from the current location of the client, the central control office tracking the location of the client by running its internal client location tracking database installed therein to ascertain the location information of the client; the central control office storing an ascertained client information; the central control office ascertaining service states of taxis under the control of the central control office and searching for an available taxi within the certain search radius from the current location of the client; if an available taxi exists within the certain search radius from the current location of the client as the search result, the central control office transmitting a map page on which the location information of the available taxi within the certain search radius is displayed and taxi information of the available taxi within the certain search radius to the client terminal; the client that received the location information of the available taxi from the central control office selecting the available taxi displayed in the client terminal and transmitting the taxi information of the selected available taxi to the central control office; the central control office transmitting the location information of the client to the available taxi selected by the client; and the available taxi moving to the location of the client.

In addition, the present invention provides a method of providing an automatic connection service for taxis using a communication network comprising the steps of: a client who desires to use a taxi accessing a central control office by executing an Internet Web browser through his own mobile communication terminal; if receiving a call signal of the client, the central control office transmitting a page to allow the client to determine whether he requires the central control office to search for an available taxi within a certain search radius from the current location of the client or a search radius desired by the client; the client entering his own request conditions-to the page transmitted from the central control office and transmitting the entered request conditions to the central control office; if the client requires the central control office to search for taxis within the desired search radius, the central control office searching for an available taxi within the desired search radius; if an available taxi exists within the desired search radius as the search result, transmitting a map page on which the location information of the available taxi within the desired search radius is displayed and taxi information of the available taxi within the desired search radius, such as the type of the available taxi, the number of the available taxi and the like, to the client terminal; the client that received the location information of the available taxi from the central control office selecting the available taxi displayed in the client terminal and transmitting taxi information of the selected available taxi to the central control office; the central control office that received taxi information of the available taxi tracking the location of the client by running its internal client location tracking database installed therein to ascertain the location information of the client; the central control office storing an ascertained client information; the central center transmitting the location information of the client to the available taxi selected by the client; and the available taxi moving to the location of the client.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating the construction of a system for providing an automatic connection service for taxis using a communication network in accordance with the present invention;

FIG. 2 is a flowchart illustrating a method of providing an automatic connection service for taxis using a communication network in accordance with a first embodiment of the present invention;

FIG. 3 is a flowchart illustrating a method of providing an automatic connection service for taxis using a communication network in accordance with a second embodiment of the present invention;

FIG. 4 is a flowchart illustrating a method of providing an automatic connection service for taxis using a communication network in accordance with a third embodiment of the present invention; and

FIGS. 5 and 6 are flowcharts illustrating a method of providing an automatic connection service for taxis using a communication network in accordance with a fourth embodiment of the present invention.

### BEST MODE FOR CARRYING OUT THE INVENTION

Hereinafter, a system and method for providing an automatic connection service for taxis using a communication network in accordance with the present invention is described in detail with reference to the accompanying drawings.

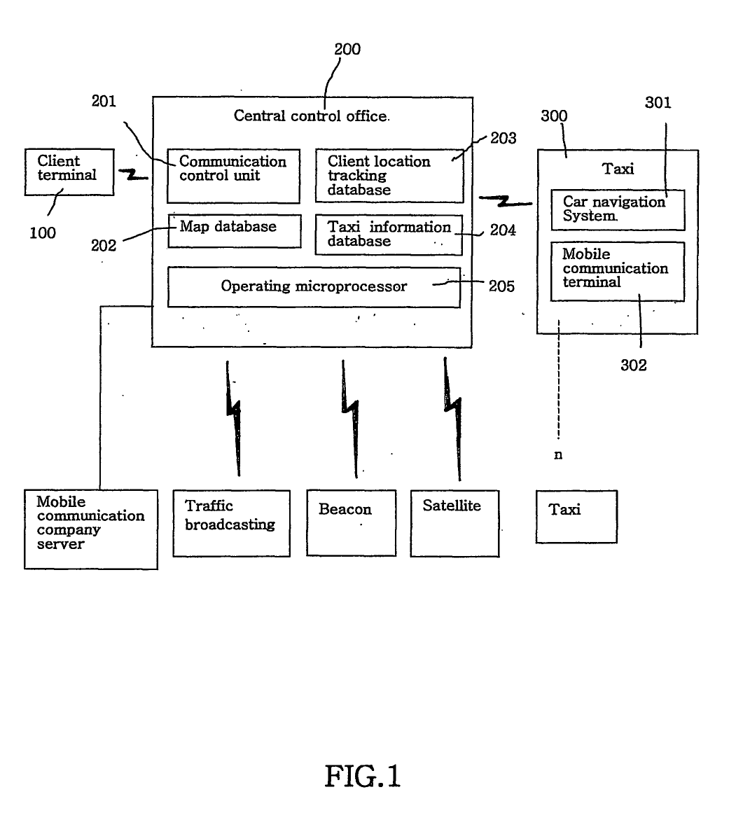

FIG. 1 is a block diagram illustrating the construction of the system for implementing the present invention. The system is a wired and wireless communication system through which a client is able to access a central control office that controls a taxi service and information relating to the taxi service. The system preferably comprises a client terminal 100, a central control office 200, and a car navigation system 301. The client terminal 100 is embodied as a Code-Division Multiple Access (CDMA) mobile communication terminal capable of accessing the wireless Internet and carrying out wireless communication, another type of wireless communication terminal, or a terminal connected to a cable communication network to carry out communication.

The central control office 200 processes traffic information, information relating to a taxi service, the location information of the client and so on. The central control office 200 comprises a communication control unit 201, a map database 202, a client location tracking database 203, a taxi information database 204, and an operating microprocessor 205. The communication control unit 201 is connected to the client terminal 100 through a wired and wireless Internet network, receives information on a taxi call signal and transmits necessary information to the client terminal 100, receives traffic information from taxis in motion, a satellite, beacons and traffic broadcasting services, and provides the traffic information to a car navigation system installed in a taxi. The map database 202 analyzes the traffic information and indicates the traffic information, such as the location of a taxi and traffic congestion, on a map. When the call signal of the client is received, the client location tracking database 203 ascertains the individual information of the client and tracks the location of the client through connections with the servers of mobile communication companies so as to track the location of the client and ascertain the individual information of the client relating to the mobile phone of the client, tracks the location of the client and records the tracked location on the map, and provides the tracked location of the client to a taxi. The taxi information database 204 stores information on a taxi under the control of the central control office 200, such as the number of the taxi, the color of the taxi and so on. The operating microprocessor 205 manages and controls the central control office 200.

The car navigation system 301 is installed in the taxi to receive the traffic information from the central control office 200, transmits the service states of taxies inputted to various kinds of sensors installed in a taxi and traffic information relating to the taxi service, and carries out the planning of the route of the taxi, the guiding of the taxi along the route and so on.

Techniques of tracking taxis and providing the traffic information in the detailed constructions of the central control office 200 of the system for providing the automatic connection service for taxis using the communication network according to the present invention have been already used in the field of the present invention or can be implemented using the prior art known domestically and overseas as disclosed in Korean Non-examined Patent Publication Nos. 1999-82385 (published on Nov. 25, 1999) and 2000-66016 (published on Nov. 15, 2000) and so on. The technique of ascertaining the location of the client using the mobile communication terminal when the client accesses the central control office 200 can be implemented using the Global Positioning System (GPS) of a cell phone, which is a prior art known domestically and overseas as disclosed in Korean Non-examined Patent Publication Nos. 2001-42540 (published on May 25, 2001) and 2001-46125 (published on Jun. 5, 2001). The car navigation system 301 installed in the taxi can be implemented using one of car navigation systems installed in vehicles, which are prior arts known domestically and overseas as disclosed in Korean Non-examined Patent Publication Nos. 2001-26896 (published on Apr. 6, 2001) and 1999-6486 (published on Aug. 5, 1999).

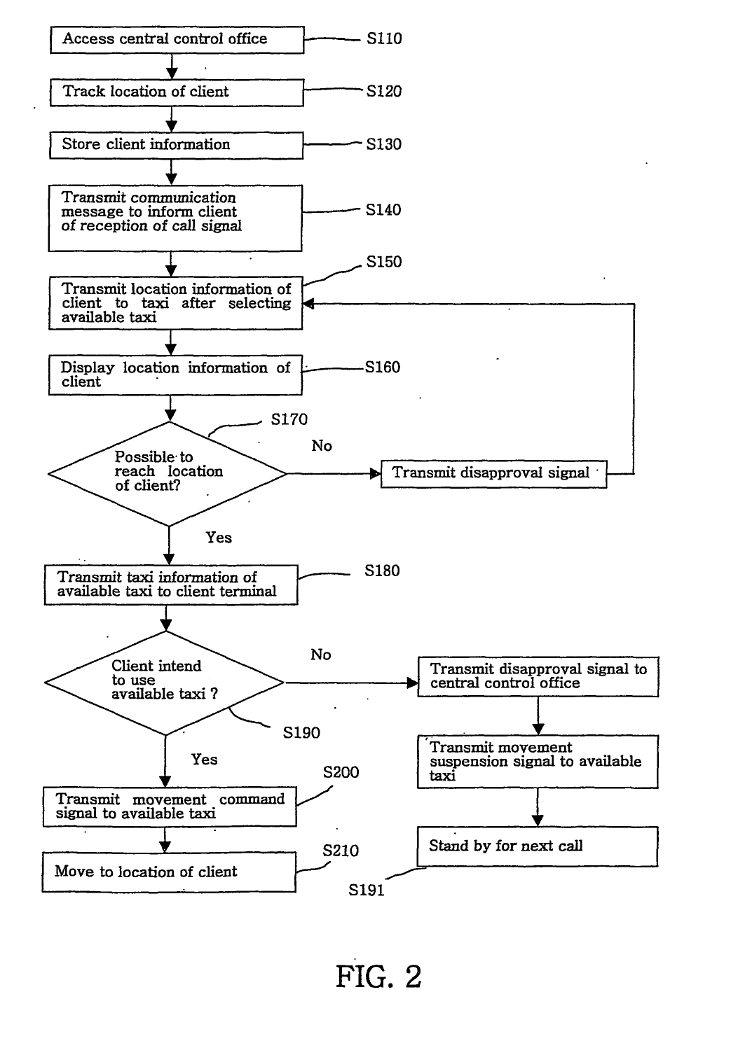

Next, in a first embodiment of the present invention, the operating process of a system for providing an automatic connection service for taxis using a communication network is described with reference to FIG. 2., which is a flowchart illustrating the process of providing an automatic connection service for taxis using a communication network in accordance with the first embodiment.

First, a client who desires to use a taxi accesses the central control office 200 on the basis of previously acquired information or information acquired by searching for the central control office 200 through his own mobile communication terminal 100 or a computer terminal 100 connected to a cable network at step S110. At this time, the client may access the central control office 200 through the voice communication function of a wired and wireless terminal as well as an Internet Web browser.

If a call signal from the client terminal 100 is inputted to the central control office 200, the operator of the central control office 200 receives and inputs the contents of a voice communication when the client uses the voice communication. In this case, the central control office 200 tracks the location of the client by running its internal client location tracking database 203 installed therein to ascertain the location information of the client at step S120. The central control office 200 ascertains the individual information of the client using a Calling Identity Delivery Service (CID), a Global Positioning System (GPS) or caller location tracking technology in conjunction with the servers of mobile communication companies, and uses the individual information as client information.

The central control office stores the client information at step S130.

The location of the client is tracked using a mobile user location tracking method, which is a prior art known in the field of the present invention. That is, the location of the client is tracked using a client's Identification when the client uses a cable Internet network (that is, location tracking technology using a database previously established by the operator of the central control office 200, or a cookie, which is a prior art known in the field of the present invention), or a method of searching the map database 202 on the basis of a client's originating address when the client uses the voice communication.

Thereafter, the central control office 200 that ascertained the location of the client transmits a communication message to the client terminal 100 through which the client accesses to inform the client of the reception of the call signal after tracking, ascertaining and storing the call signal, and extracting the phone number of the client from the stored client information at step S140.

Thereafter, the central control office 200 that ascertained the location of the client ascertains the service states of taxis under the control of the central control office 200, selects an available taxi 300 closest to the location of the client, and transmits the location information of the client, client information, such as the phone number of the client, the name of the client and the like, and map information to indicate the location of the client to the car navigation system 301 of the selected available taxi 300 at step S150. Hereinafter, the client information, such as the location, the phone number, the name of the client and the like, and map information is referred to as location information.

The location information of the client is transmitted to the car navigation system 301 of the selected available taxi 300 in the present invention, and is also transmitted to the mobile communication terminal of the driver of the taxi via a wireless Internet with the location information of the client displayed on the map. Hereinafter, the reception of the location information of the client by the car navigation system 301 is described, and the reception of the location information of the client by the mobile communication terminal of the taxi driver is omitted because the reception by the mobile communication terminal is similar to the reception of the car navigation system 301.

In this case, the central control office 200 can ascertain whether a taxi 300 is available by communicating with the car navigation system 301, which is a prior art known in the field of the present invention, or informing the central control office 200 of the availability of the taxi 300 through the mobile communication terminal of the taxi driver, and can track the location of the taxi 300 by using the mobile user location tracking system.

The car navigation system 301 installed in the taxi 300 continuously communicates location signals generated in the car navigation system 301, which is comprised of a satellite navigation equipment using a satellite, a self-contained navigation equipment utilizing an azimuth sensor, a wheel sensor and the like installed in the taxi 300 or a Hybrid navigation system combining the satellite navigation equipment with the self-contained navigation equipment and which is described in the prior art known domestically and overseas as disclosed in Korean Non-examined Patent Publication Nos. 2001-26896 (published on Apr. 6, 2001) and 1999-6486 (published on Aug. 5, 1999), and information relating to the taxi service generated in a service recorder and a taxi charge meter through a mobile communication, satellite communication and the like, so the central control office 200 can ascertain the location of the taxi 300 and whether the taxi 300 is available, and transmit and receive the location information of the client

The car navigation system 301 of the available taxi 300 that received the location information of the client from the central control office 200 displays map information in which the location information of the client is indicated on the display device of the car navigation system 301 at step S160.

Thereafter, the driver of the available taxi 300 checks the location of the client, determines whether he can reach the location of the client by considering current travel conditions such as the current state of his taxi, and informs the central control office 200 of the determination result of step S170. At this time, an optimal route to the location of the client relating to a predicted arrival time at the location of the client and the like may be calculated and transmitted to the central control office 200 according to the function of the car navigation system 301 and the operational characteristics of the central control office 200.

If receiving an approval signal, which indicates that it is possible to reach the location of the client, from the available taxi 300, the central control office 200 calculates the optimal route to the location of the client, and tracks, ascertains and stores a predicted arrival time and taxi information to identify the available taxi 300 which the client has called, such as the color of the available taxi 300, the number of the available taxi 300 and the like using inherent information relating to the available taxi 300 which the operator of the central control office 200 has previously established, extracts the phone number of the client from the stored client information, and transmits the taxi information of the available taxi 300 to the mobile communication terminal of the client at step S180. Additionally, the optimal route is transmitted to the available taxi 300 along with the location information of the client in the case where the central control office 200 calculates the optimal route.

The taxi 300 transmits a disapproval signal, which indicates that it is impossible to reach the location of the client, to the central control office 200 in the case where the available taxi 300 closest to the location of the client receives the location information of the client from the central control office 200 but can not accept the client, and the central control office 200 proceeds to step S150 to search for another available taxi 300.

In contrast, the client that received the predicted arrival time of the available taxi 300 and the taxi information of the available taxi 300 from the central control office 200 carries out the step of confirming his intention of using the available taxi 300 by determining whether the client uses the available taxi 300 at step S190.

When the client rejects the available taxi 300 because the conditions of the available taxi 300 are not appropriate, the client transmits a disapproval signal to the central control office 200 through the client terminal 100, the central control office 200 that received the disapproval signal transmits a movement suspension signal to prevent the available taxi 300, which answered that it was possible to reach the location of the client, from moving to the location of the client, so the central control office 200 recognizes the available taxi 300 as an available taxi and the available taxi stands by for the next call from a client at step S191.

If the client accepts the available taxi 300, an approval signal is transmitted to the central control office 200 through the client terminal 100, the central control office 200 that received the approval signal transmits a movement command signal to command the available taxi 300, which answered that it was possible to reach the location of the client, to move to the location of the client at step S200, and the available taxi 300 moves to the location of the client at step S210.

Additionally, using the prior art of operating the car navigation system known in the field of the present invention, the central control office 200 displays traffic information, such as map information, road conditions and congestion situations, according to the location of the taxi 300 on a map in real time, and transmits the traffic information to be displayed on the monitor of the car navigation system 301 and the like installed in the taxi 300. The car navigation system 301 receives the traffic information and displays the traffic information on a display device, such as a monitor. The taxi driver drives the taxi 300 by selecting an optimal route to the destination with reference to the traffic information. The client can learn the states his taxi by watching and hearing the traffic information, so the car navigation system 301 contributes to client service.

Additionally, the car navigation system 301 installed in the taxi 300 informs the central control office 200 of its own service situation in real time, so the central control office 200 can easily ascertain the traffic information. This is applied to all embodiments described later, in addition to the first embodiment.

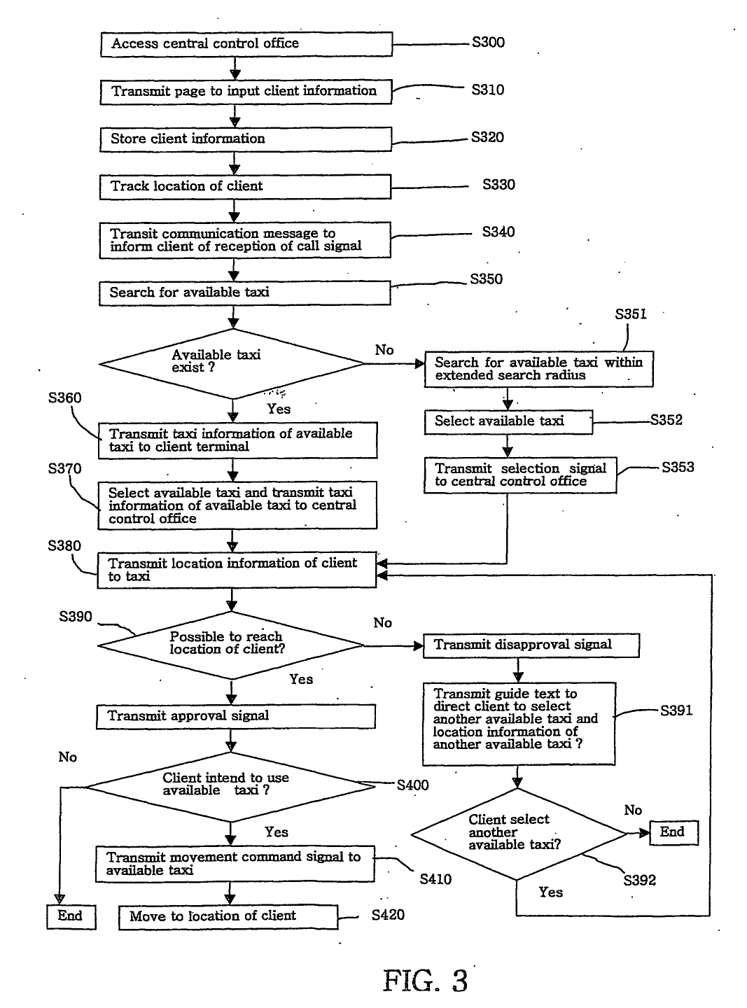

Next, in a second embodiment of the present invention, the operating process of a system for providing an automatic connection service for taxis using a communication network is described with reference to FIG. 3., which is a flowchart illustrating a method of providing an automatic connection service for taxis using a communication network in accordance with the second embodiment in which a client selects an available taxi.

Only the operating process is briefly described in conjunction with the second embodiment because technical contents, such as a location tracking method, an operation method of the car navigation system and the like, which are applied to the second embodiment of the present invention, are the same as those of the first embodiment.

First, a client who desires to use a taxi accesses the central control office 200 on the basis of previously acquired information or information acquired by searching for the central control office 200 after executing a wireless Internet or an Internet Web browser through his own mobile communication terminal 100 or a computer terminal 100 connected to a cable network, at step S300.

If a call signal from the client terminal 100 is inputted to the central control office 200, the operating microprocessor 205 of the central control office 200 transmits a page on which the client can input information, that is, client information, such as the type of a taxi (deluxe taxi, medium company taxi or privately owned taxi), the arrival time and number of taxis, the color of the client's clothes, the phone number of the client and the range of search radius from the location of client to an available taxi 300, for example, 1 Km, 2 Km, 3 Km, . . . , and so on in the case where the client terminal 100 accesses the central control office 200 via the Internet, at step S310.

Thereafter, the central control office 200 stores the inputted client information at step S320.

Thereafter, the central control office 200 tracks the location of the client by running its internal client location tracking database 203 installed therein to ascertain the location information of the client at step S330.

Thereafter, the central control office 200 that ascertained the location of the client transmits a communication message to the client terminal 100 through which the client accesses the central control office 200 to inform the client of the reception of the call signal at step S340.

Thereafter, the central control office 200 ascertains the service states of taxis under the control of the central control office 200, and searches for an available taxi 300 within the search radius set by the client at step S350.

At this time, if no available taxi 300 exists within the search radius set by the client, the central control office 200 searches for an available taxi 300 within a next stage search radius (for example, 1 km, 2 km, 3 km, . . . , N km; N is increased by integers, but can be varied according to the operation of the central control office 200 and system conditions) larger than the search radius set by the client at step S351.

The search result of the step S351, a guide text to inform the client that no available taxi 300 exists within the search radius set by the client, a page to inform the client that an available taxi 300 exists when the central control office 200 extends the search radius and searches for the available taxi 300 within the extended search radius, and a page to allow the client to determine whether the client accepts the searched available taxi 300 are transmitted to the client terminal 100 at step S352.

If the client selects the searched available taxi 300 within the search radius extended by the operator of the central control office 200, the client terminal 100 transmits a selection signal to the central control office 200 at step S353, and step S380 later described is carried out. On the other hand, if the client does not respond to the transmitted pages within a certain period of time or transmits a disapproval signal to inform the central control office 200 that he does not intend to use the available taxi 300, the process is terminated. In the present invention, the certain time is defined as 30 seconds, but can be varied by the system operator of the central control office 200.

If an available taxi 300 exists within the search radius set by the client as the search result of the step S350, a map page on which the location information of the available taxi 300 is displayed, and the taxi information of the available taxi 300, such as the type of the available taxi 300, the number of the available taxi 300 and the like, are transmitted to the client terminal 100 at step S360.

The client that received the location information of the available taxi 300 from the central control office 200 selects the available taxi 300 displayed in the client terminal 100 and transmits the taxi information of the selected available taxi 300 to the central control office 200 at step S370.

The central control office 200 transmits the location information of the client to the available taxi 300 selected by the client at step S380.

The driver of the available taxi 300 that received the location information of the client determines whether he can reach the location of the client by considering current travel conditions and informs the central control office 200 of the determination result of step S390.

At this time, if the available taxi 300 transmits a disapproval signal, which indicates that it is impossible to reach the location of the client, to the central control office 200, the location information of another available taxi 300 except for the previously selected available taxi 300, along with a guide text to direct the client to select another available taxi 300, are transmitted to the client at step S391.

If the client selects another available taxi 300 according to the request of the central control office 200 at step S392, step S380 is carried out.

The central control office 200 that received an approval signal, which indicates that it is possible to reach the location of the client, from the available taxi 300, calculates an optimal route to the location of the client, transmits a predicted arrival time and taxi information, such as the number of the available taxi 300, to allow the available taxi 300 selected by the client to be identified, to the client, and confirms the intention of the client to use the available taxi 300 at step S400.

If the client transmits an approval signal to the central control office 200, the central control office 200 transmits a movement command signal to command the available taxi 300 to move to the location of the client at step S410, and the process is terminated if the available taxi 300 moves to the location of the client at step S420.

At this time, if the client transmits a disapproval signal to the central control office 200 or does not respond within a certain period of time, the central control office 200 informs the available taxi 300 that the call is cancelled, the available taxi 300 stands by for the next call, as an available taxi, and then the process is terminated. In the present invention, the certain time is defined as 30 seconds, but can be changed by the system operator of the central control office 200.

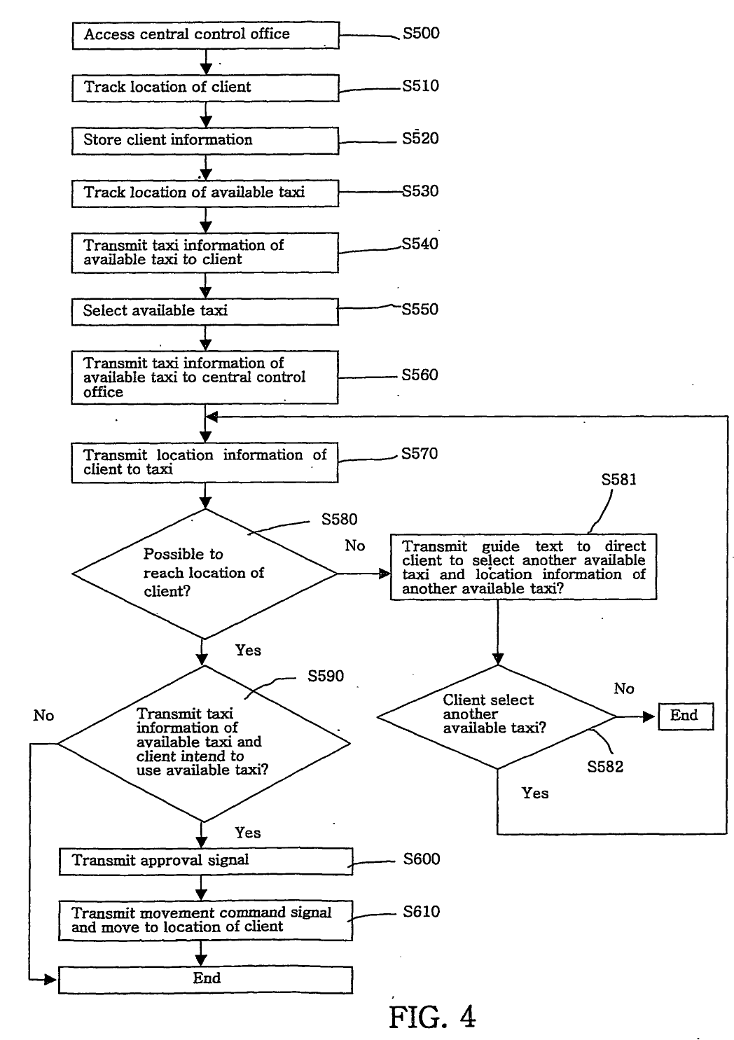

Next, in a third embodiment of the present invention, the operating process of a system for providing an automatic connection service for taxis using a communication network is described with reference to FIG. 4., which is a flowchart illustrating the process of providing an automatic connection service for taxis using a communication network in accordance with the third embodiment in which a client selects an available taxi.

The operating process is briefly described in the third embodiment because technical contents, such as a location tracking method, an operation method of the car navigation system and the like, which are applied to the second embodiment of the present invention, are the same as those of the first embodiment.

First, a client who desires to use a taxi accesses the central control office 200 on the basis of previously acquired information or information acquired by searching for the central control office 200 after executing a wireless Internet or an Internet Web browser through his own mobile communication terminal 100 or a computer terminal 100 connected to a cable network, at step S500.

Thereafter, the central control office 200 tracks the location of the client by running its internal client location tracking database 203 installed therein to ascertain the location information of the client at step S500.

At this time, the central control office 200 ascertains the individual information of the client 100 using a Calling Identity Delivery Service (CID), a Global Positioning System (GPS) or caller location tracking technology in conjunction with the servers of mobile communication companies, and uses the individual information as client information.

Thereafter, the central control office 200 stores the ascertained client information at step S520.

If the location of the client is ascertained, the central control office 200 ascertains service states of taxis under the control of the central control office 200, and searches for an available taxi 300 within a certain search radius at step S530. The search radius is 5 km in the present invention and can be varied at the operator's request.

Thereafter, the central control office 200 transmits a map page on which the location information of the searched available taxi 300 within the certain search radius is displayed and the taxi information of the available taxi 300 within the certain search radius, such as the type of the available taxi 300, the number of the available taxi 300 and the like, to the client terminal 100 at step S540.

The client that received the location information of the available taxi 300 from the central control office 200 selects the available taxi 300 displayed in the client terminal 100 at step S550 and transmits the taxi information of the selected available taxi 300 to the central control office 200 at step S560.

The central control office 200 transmits the location information of the client to the available taxi 300 selected by the client at step S570.

The driver of the available taxi 300 that received the location information of the client determines whether he can reach the location of the client by considering current travel conditions and informs the central control office 200 of the determination result at step S580.

At this time, if the available taxi 300 transmits a disapproval signal, which indicates that it is impossible to reach the location of the client, to the central control office 200, the location information of another available taxi 300 except for the previously selected available taxi 300, along with a guide text to direct the client to select another available taxi 300, are transmitted to the client at step S581.

If the client selects another available taxi 300 according to the request of the central control office 200 at step S582, step S570 is carried out.

The central control office 200 that received an approval signal, which indicates that it is possible to reach the location of the client, from the available taxi 300, calculates an optimal route to the location of the client, transmits a predicted arrival time and taxi information, such as the number of the available taxi 300, to allow the available taxi 300 selected by the client to be identified, to the client, and confirms the intention of the client to use the available taxi 300 at step S590.

If the client transmits an approval signal to the central control office 200 at step S600, the central control office 200 transmits a movement command signal to command the available taxi 300 to move to the location of the client and the process is terminated if the available taxi 300 moves to the location of the client at step S610.

At this time, if the client transmits a disapproval signal to the central control office 200 or does not respond within a certain period of time, the central control office 200 informs the available taxi 300 that the call is cancelled, the available taxi 300 stands by for the next call, as an available taxi, and then the process is terminated. In the present invention, the certain time is defined as 30 seconds, but can be changed by the system operator of the central control office 200.

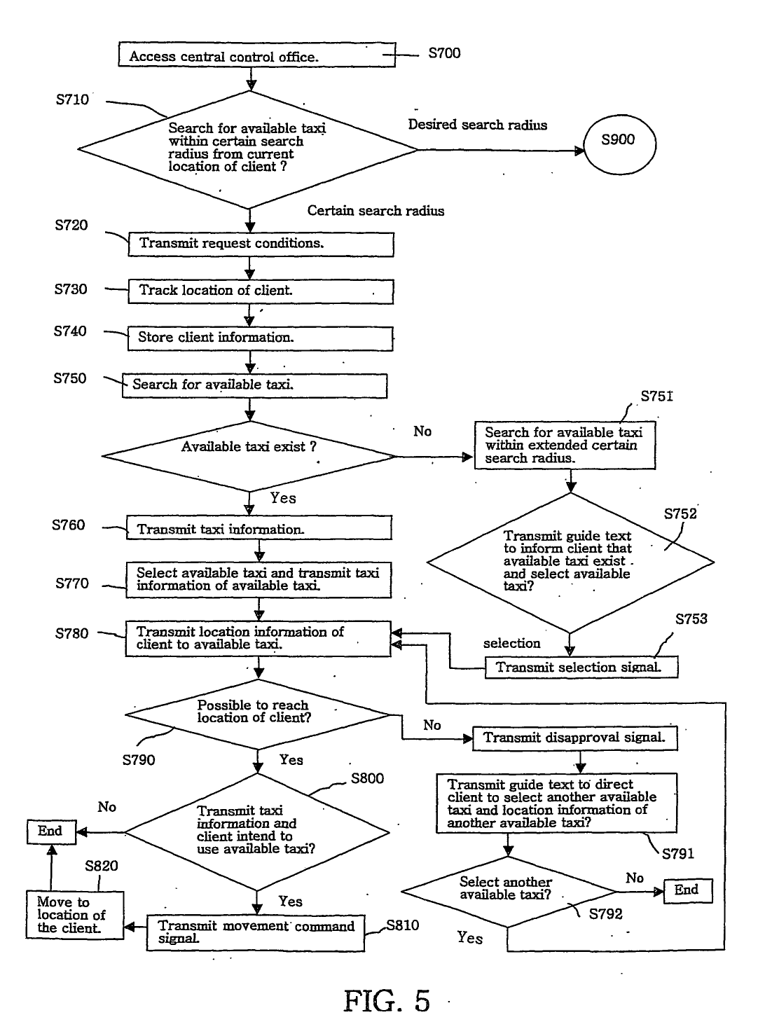

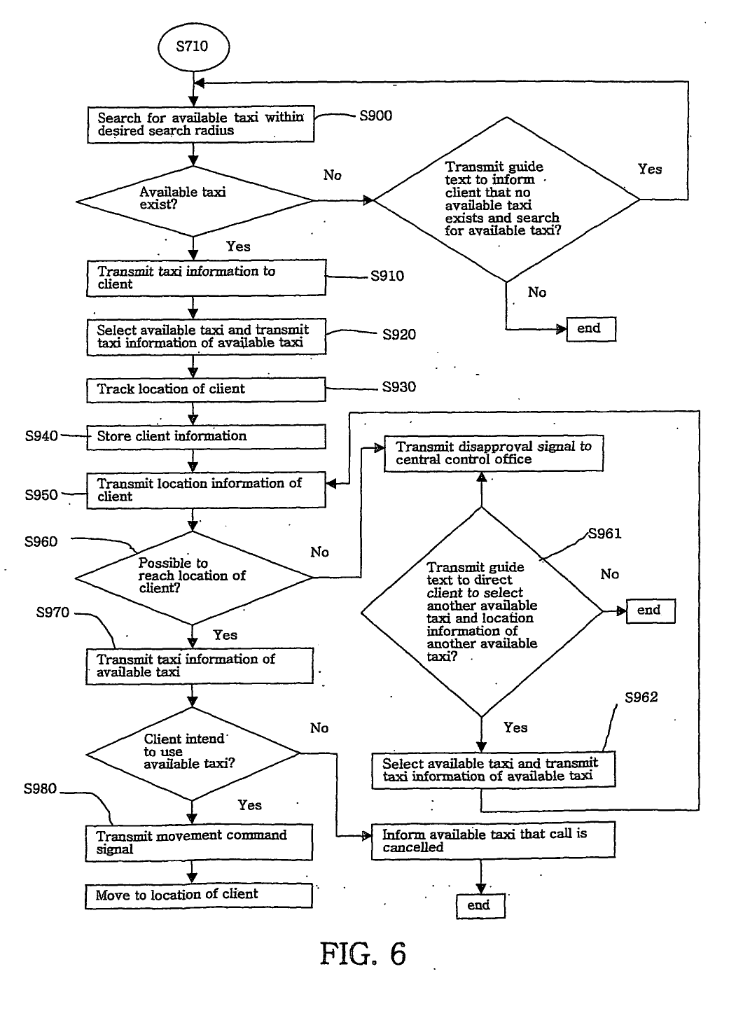

Next, for a fourth embodiment of the present invention, the operating process of a system for providing an automatic connection service for taxis using a communication network is described with reference to FIGS. 5 and 6, which is a flowchart illustrating a method of providing an automatic connection service for taxis using a communication network in accordance with the fourth embodiment in which a client selects an available taxi.

The operating process is briefly described in the fourth embodiment because technical contents, such as a location tracking method, an operation method of the car navigation system and the like, which are applied to the fourth embodiment of the present invention, are the same as those of the first embodiment.

First, a client who desires to use a taxi accesses the central control office 200 on the basis of previously acquired information or information acquired by searching for the central control office 200 after executing a wireless Internet or an Internet Web browser through his own mobile communication terminal 100 or a computer terminal 100 connected to a cable network, at step S700.

If the central control office 200 receives a call signal of the client, the central control office 200 transmits a page to allow the client to determine whether he requires the central control office 200 to search for an available taxi 300 within a certain search radius from the current location of the client or a search radius desired by the client. In this case, the page is transmitted along with a window for inputting request conditions of the client according to the determination, that is, a search radius, for example, 1 Km, 2 Km, 3 Km, . . . , and a search area, for example, Yoksam-dong, Kangnam-Gu, and the like at step S710.

The client enters his own request conditions to the page transmitted from the central control office 200 and transmits the entered request conditions to the central control office 200 at step S720. At step S720, if the client requires the central control office 200 to search for an available taxi 300 that exists within the certain search radius from the current location of the client, the central control office 200 tracks the location of the client by running its internal client location tracking database 203 installed therein to ascertain the location information of the client at step S730.

At this time, the central control office 200 ascertains the individual information of the client 100 using a Calling Identity Delivery Service (CID), a Global Positioning System (GPS) or caller location tracking technology in conjunction with the servers of mobile communication companies, and uses the individual information as client information.

Thereafter, the central control office 200 stores the ascertained client information at step S740.

Thereafter, the central control office 200 ascertains service states of taxis under the control of the central control office 200, and searches for an available taxi 300 that exists within the certain search radius from the current location of the client at step S750. If the client does not enter the certain search radius, the central control office 200 sets the certain search radius, for example, 5 km in the present invention, and the certain search radius can be varied at the operator's request.

At this time, if no available taxi 300 exists within the certain search radius from the current location of the client, the central control office 200 searches for an available taxi 300 within a next stage search radius, for example, 1 km, 2 km, 3 km, . . . , Nkm, larger than the certain search radius from the current location of the client at step S751. N is increased by integers, but can be varied according to the operation of the central control office 200 and system conditions.

The search result of the step S751, a guide text to inform the client that no available taxi 300 exists within the certain search radius, a page to inform the client that an available taxi 300 exists when the central control office 200 extends the certain search radius and searches for the available taxi 300 within the extended search radius, and a page to allow the client to determine whether the client accepts the searched available taxi 300 are transmitted to the client terminal 100 at step S752.

If the client selects the searched available taxi 300 within the search radius extended by the operator of the central control office 200, the client terminal 100 transmits a selection signal to the central control office 200 at step S753, and step S780 later described is carried out. On the other hand, if the client does not respond to the transmitted pages within a certain period of time or transmits a disapproval signal to inform the central office 200 that the client does not intend to call the available taxi 300, the process is terminated. In the present invention, the certain time is defined as 30 seconds, but can be changed by the system operator of the central control office 200.

If an available taxi 300 exists within the certain search radius from the current location of the client as the search result, the central control office 200 transmits a map page on which the location information of the available taxi 300 within the certain search radius along with the location of the client are displayed and the taxi information of the available taxi 300 within the certain search radius, such as the type of the available taxi 300, the number of the available taxi 300 and the like, to the client terminal 100 at step S760.

The client that received the location information of the available taxi 300 from the central control office 200 selects the available taxi 300 displayed in the client terminal 100 and transmits the taxi information of the selected available taxi 300 to the central control office 200 at step S770.

The central control office 200 transmits the location information of the client to the available taxi 300 selected by the client at step S780.

The driver of the available taxi 300 that received the location information of the client determines whether he can reach the location of the client by considering current travel conditions and informs the central control office 200 of the determination result at step S790.

At this time, if the available taxi 300 transmits a disapproval signal, which indicates that it is impossible to reach the location of the client, to the central control office 200, the location information of another available taxi 300 except for the previously selected available taxi 300, along with a guide text to direct the client to select another available taxi 300, are transmitted to the client at step S791.

If the client selects another available taxi 300 according to the request of the central control office 200 at step S792, step S780 is carried out.

The central control office 200 that received an approval signal, which indicates that it is possible to reach the location of the client, from the available taxi 300, calculates an optimal route to the location of the client, transmits a predicted arrival time and taxi information, such as the number of the available taxi 300, to allow the available taxi 300 selected by the client to be identified, to the client, and confirms the intention of the client to use the available taxi 300 at step S800.

If the client transmits an approval signal to the central control office 200, the central control office 200 transmits a movement command signal to command the available taxi 300 to move to the location of the client at step S810, and the process is terminated if the available taxi 300 moves to the location of the client at step S820.

At this time, if the client transmits a disapproval signal to the central control office 200 or does not respond within a certain period of time, the central control office 200 informs the available taxi 300 that the call is cancelled, the available taxi 300 stands by for the next call, as an available taxi, and then the process is terminated. In the present invention, the certain time is defined as 30 seconds, but can be changed by the system operator of the central control office 200.

At step S720, if the client requires the central control office 200 to search for taxis within the desired search radius, the central control office 200 searches for an available taxi 300 within the desired search radius at step S900. At this time, if no available taxi 300 exists within the desired search radius at step S901, the central control office 200 transmits a guide text to inform the client that an available 300 taxi within the desired search radius, and a page to allow the client to determine whether he requires the central control office 200 to search for an available taxi 300 within a changed search radius to the client terminal 100 at step S902.

If the client selects the available taxi 300 within the changed search radius, the client terminal 100 transmits a selection signal to the central control office 200, and step S900 is carried out. On the other hand, if the client does not respond to the transmitted pages within a certain period of time or transmits a disapproval signal to inform the central control office 200 that he does not intend to use the available taxi 300, the process is terminated. In the present invention, the certain period of time is defined as 30 seconds, but can be varied by the system operator of the central control office 200.

If an available taxi 300 exists within the desired search radius as the search result, a map page on which the location information of the available taxi 300 within the desired search radius is displayed and the taxi information of the available taxi 300 within the desired search radius, such as the type of the available taxi 300, the number of the available taxi 300 and the like, are transmitted to the client terminal 100 at step S910.

The client that received the location information of the available taxi 300 from the central control office 200 selects the available taxi 300 displayed in the client terminal 100 and transmits the taxi information of the selected available taxi 300 to the central control office 200 at step S920.

Thereafter, the central control office 200 that received the taxi information tracks the location of the client by running its internal client location tracking database 203 installed therein to ascertain the location information of the client at step S930.

In this case, the central control office 200 ascertains the individual information of the client 100 using a Calling Identity Delivery Service (CID), a Global Positioning System (GPS) or caller location tracking technology in conjunction with the servers of mobile communication companies, and uses the individual information as client information.

Thereafter, the central control office 200 stores the ascertained client information at step S940.

The central center 200 transmits the location information of the client to the available taxi 300 selected by the client at step S950.

The driver of the available taxi 300 that received the location information of the client determines whether he can reach the location of the client by considering current travel conditions and informs the central control office 200 of the determination result at step S960.

At this time, if the available taxi 300 transmits a disapproval signal, which indicates that it is impossible to reach the location of the client, to the central control office 200,the location information of another available taxi 300 except for the previously selected available taxi 300, along with a guide text to direct the client to select another available taxi 300, are transmitted to the client at step S961.

If the client selects another available taxi 300 according to the request of the central control office 200 at step S962, the step S950 is carried out.

The central control office 200 that received an approval signal, which indicates that it is possible to reach the location of the client, from the available taxi 300, calculates an optimal route to the location of the client, transmits a predicted arrival time and taxi information, such as the number of the available taxi 300, to allow the available taxi 300 selected by the client to be identified, to the client, and confirms the intention of the client to use the available taxi 300 at step S970.

If the client transmits an approval signal to the central control office 200, the central control office 200 transmits a movement command signal to command the available taxi 300 to move to the location of the client at step S980, and the process is terminated if the taxi 300 moves to the location of the client at step S990.

At this time, if the client transmits a disapproval signal to the central control office 200 or does not respond within a certain period of time, the central control office 200 informs the available taxi 300 that the call is cancelled, and the available taxi 300 stands by for the next call, as an available taxi 300 and then the process is terminated at step S1000. In the present invention, the certain time is defined as 30 seconds, but can be changed by the system operator of the central control office 200.

Although the preferred embodiments of the present invention is described to be limitedly applied to a taxi to easily describe the embodiments, the embodiments may also be applied to other industries that provide transportation services using a communication network, that is, other transportation businesses such as a freight transport business and so on.

Industrial Applicability

As described above, the present invention provides a method of providing an automatic connection service for taxis using the wireless Internet function of an mobile communication terminal and a car navigation system installed on a taxi, which allows a client to selectively call one of various taxis within a desired region, by automatically tracking the location of the client, searching for an available taxi within a search radius corresponding to the requested conditions of the client on the basis of the tracked information, transmitting a map information in which the location information of the client is indicated to the searched available taxi, and providing the client with the information of the available taxi, thus improving the quality of taxi call services using a communication terminal such as a mobile communication terminal and the like, increasing the convenience of users, preventing traffic congestion caused by vacant taxis moving to pick up passengers, and increasing the efficiency of taxi business through the saving of fuel and so on.

1. A method of providing an automatic connection service for taxis using a communication network comprising the steps of:
a client who desires to use a taxi accessing a central control office through his own mobile communication terminal;
the central control office tracking the location of the client by running its internal client location tracking database installed therein to ascertain the location information of the client;
the central control office storing an ascertained client information;
the central control office ascertaining service states of taxis under the control of the central control office, selecting an available taxi closest to the location of the client, and transmitting the location information of the client to a car navigation system of the selected available taxi;
the car navigation system of the available taxi that received the location information of the client from the central control office displaying map information in which the location information of the client is indicated on a display device of the car navigation system;
a driver of the available taxi checking the location of the client, determining whether he can reach the location of the client by considering current travel conditions such as the current state of his taxi, and informing the central control office of the determination result;
if receiving an approval signal, which indicates that it is possible to reach the location of the client, from the available taxi, the central control office calculating an optimal route to the location of the client, and tracking, ascertaining and storing a predicted arrival time and taxi information to identify the available taxi which the client has called, such as the color and number of the available taxi, extracting a phone number of the client from the stored client information, and transmitting taxi information of the available taxi to the client terminal; and
the available taxi that received the client information from the central control office moving to the location of the client.

2. The method according to claim 1, wherein the step of accessing the central control office is performed by an operator of the central control office receiving the location of the client through a voice communication function of a wire and wireless terminal and inputting the location of the client to a system of central control office.

3. The method according to claim 1, further comprising the step of the central control office transmitting a communication message to the client terminal through which the client accesses to inform the client of the reception of a call signal after tracking, ascertaining and storing the call signal, and extracting the phone number of the client from the stored client information after the step of the central control office storing an ascertained client information, and before the step of the central control office ascertaining service states of taxis under the control of the central control office, selecting an available taxi closest to the location of the client, and transmitting the location information of the client to a car navigation system of the selected available taxi.

4. The method according to claim 1, further comprising the steps of:
if the available taxi closest to the location of the client receives the location information of the client from the central control office but can not accept the client, the available taxi transmitting a disapproval signal, which indicates that it is impossible to reach the location of the client, to the central control office;
the central control office that received the disapproval signal ascertaining service states of taxis under the control of the central control office, selecting an available taxi closest to the location of the client, and transmitting client information such as an appearance of the client along with the location information of the client and map information in which the location information of the client is indicated to the car navigation system of the selected available taxi; and
proceeding to the step of the car navigation system of the available taxi displaying map information;
wherein the driver of the available taxi checks the location of the client, determines whether he can reach the location of the client by considering current travel conditions such as the current state of his taxi, and informs the central control office of the determination result,.

5. The method according to claim 1, further comprising the steps of:
the client that received the predicted arrival time of the available taxi and the taxi information of the available taxi from the central control office carrying out the step of confirming his intention of using the available taxi by determining whether the client uses the available taxi;
if the client accepts the available taxi, transmitting an approval signal to the central control office through the client terminal; and
the central control office that received the approval signal transmitting a movement command signal to command the available taxi, which answered that it was possible to reach the location of the client, to move to the location of the client;
after the central control office calculating an optimal route to the location of the client, and tracking, ascertaining and storing a predicted arrival time and taxi information to identify the available taxi which the client has called, such as the color and number of the available taxi, extracting a phone number of the client from the stored client information, and transmitting taxi information of the available taxi to the client terminal if receiving an approval signal, which indicates that it is possible to reach the location of the client, from the available taxi, and before the step of the available taxi moving to the location of the client.

6. The method according to claim 1, wherein traffic information displayed on a map provided by the central control office, or traffic information generated by the car navigation system installed in the available taxi and displayed on a map of the taxi, is displayed in conjunction with the location of the available taxi which moves to the location of the client, or accepts the client therein and moves to the destination of the client.

7. A method of providing an automatic connection service for taxis using a communication network comprising the steps of:
a client who desires to use a taxi accessing a central control office through his own mobile communication terminal;
the central control office tracking the location of the client by running its internal client location tracking database installed therein to ascertain the location information of the client;
the central control office storing an ascertained client information;
if the location of the client is ascertained, the central control office ascertaining service states of taxis under the control of the central control office, and searching for an available taxi within a certain search radius;
the central control office transmitting a map page on which the location information of the searched available taxi within the certain search radius is displayed and taxi information of the available taxi within the certain search radius such as the type and number of the available taxi to the client terminal;
the client that received the location information of the available taxi from the central control office selecting the available taxi displayed in the client terminal;
the client transmitting the taxi information of the selected available taxi to the central control office;
the central control office transmitting the location information of the client to the available taxi selected by the client; and
a driver of the available taxi that received the location information of the client moving to the location of the client.

8. The method according to claim 7, further comprising the steps of:
the driver of the available taxi that received the location information of the client determining whether he can reach the location of the client by considering current travel conditions and informing the central control office of the determination result;
the central control office that received an approval signal, which indicates that it is possible to reach the location of the client, calculating an optimal route to the location of the client, transmitting a predicted arrival time and taxi information, such as the number of the available taxi, to allow the available taxi selected by the client to be identified, to the client, and confirming the intention of the client to use the available taxi;
the client transmitting an approval signal to the central control office and the central control office transmitting a movement command signal to command the available taxi; and
the available taxi that received the movement command signal moving to the location of the client;
after the step of the central control office transmitting the location information of the client to the available taxi selected by the client.

9. The method according to claim 7, wherein traffic information displayed on a map provided by the central control office, or traffic information generated by the car navigation system installed in the available taxi and displayed on a map of the taxi, is displayed in conjunction with the location of the available taxi which moves to the location of the client, or accepts the client therein and moves to the destination of the client.

10. A method of providing an automatic connection service for taxis using a communication network comprising the steps of:
a client who desires to use a taxi accessing a central control office by executing an Internet Web browser through his own mobile communication terminal;
if receiving a call signal of the client, the central control office transmitting a page to allow the client to determine whether he requires the central control office to search for an available taxi within a certain search radius from the current location of the client or a search radius desired by the client;
the client entering his own request conditions to the page transmitted from the central control office and transmitting the entered request conditions to the central control office;
if the client requires the central control office to search for an available taxi within the certain search radius from the current location of the client, the central control office tracking the location of the client by running its internal client location tracking database installed therein to ascertain the location information of the client;
the central control office storing an ascertained client information;
the central control office ascertaining service states of taxis under the control of the central control office and searching for an available taxi within the certain search radius from the current location of the client;
if an available taxi exists within the certain search radius from the current location of the client as the search result, the central control office transmitting a map page on which the location information of the available taxi within the certain search radius is displayed and taxi information of the available taxi within the certain search radius to the client terminal;
the client that received the location information of the available taxi from the central control office selecting the available taxi displayed in the client terminal and transmitting the taxi information of the selected available taxi to the central control office;
the central control office transmitting the location information of the client to the available taxi selected by the client; and
the available taxi moving to the location of the client.

11. The method according to claim 10 further comprising the steps of:
a driver of the available taxi that received the location information of the client determining whether he can reach the location of the client by considering current travel conditions and informing the central control office of the determination result;
the central control office that received an approval signal, which indicates that it is possible to reach the location of the client, calculating an optimal route to the location of the client, transmitting a predicted arrival time and taxi information, such as the number of the available taxi, to allow the available taxi selected by the client to be identified, to the client, and confirming the intention of the client to use the available taxi; and
the client transmitting an approval signal to the central control office and the central control office transmitting a movement command signal to command the available taxi;
after the step of the central control office transmitting the location information of the client to the available taxi selected by the client, and before the step of the available taxi moving to the location of the client.

12. The method according to claim 10, wherein traffic information displayed on a map provided by the central control office, or traffic information generated by the car navigation system installed in the available taxi and displayed on a map of the taxi, is displayed in conjunction with the location of the available taxi which moves to the location of the client, or accepts the client therein and moves to the destination of the client.

13. The method according to claim 10, further comprising the steps of:
if no available taxi exists within the certain search radius from the current location of the client, the central control office searching for an available taxi within a next stage search radius larger than the certain search radius from the current location of the client;
transmitting a guide text to inform the client that no available taxi exists within the certain search radius, a page to inform the client that an available taxi exists when the central control office extends the certain search radius and searches for the available taxi within the extended search radius, and a page to allow the client to determine whether the client accepts the searched available taxi to the client terminal; and
if the client selects the searched available taxi within the search radius extended by the operator of the central control office, the client terminal transmitting a selection signal to the central control office;
after the step of the central control office ascertaining service states of taxis under the control of the central control office and searching for an available taxi within the certain search radius from the current location of the client, and before the step of the central control office transmitting the location information of the client to the available taxi selected by the client.

14. A method of providing an automatic connection service for taxis using a communication network comprising the steps of:
a client who desires to use a taxi accessing a central control office by executing an Internet Web browser through his own mobile communication terminal;
if receiving a call signal of the client, the central control office transmitting a page to allow the client to determine whether he requires the central control office to search for an available taxi within a certain search radius from the current location of the client or a search radius desired by the client;
the client entering his own request conditions to the page transmitted from the central control office and transmitting the entered request conditions to the central control office;
if the client requires the central control office to search for taxis within the desired search radius, the central control office searching for an available taxi within the desired search radius;
if an available taxi exists within the desired search radius as the search result, transmitting a map page on which the location information of the available taxi within the desired search radius is displayed and taxi information of the available taxi within the desired search radius, such as the type of the available taxi, the number of the available taxi and the like, to the client terminal;
the client that received the location information of the available taxi from the central control office selecting the available taxi displayed in the client terminal and transmitting taxi information of the selected available taxi to the central control office;
the central control office that received taxi information of the available taxi tracking the location of the client by running its internal client location tracking database installed therein to ascertain the location information of the client;
the central control office storing an ascertained client information;
the central center transmitting the location information of the client to the available taxi selected by the client; and
the available taxi moving to the location of the client.

15. The method according to claim 14, further comprising the steps of:
the driver of the available taxi that received the location information of the client determining whether he can reach the location of the client by considering current travel conditions and informing the central control office of the determination result;
the central control office that received an approval signal, which indicates that it is possible to reach the location of the client, calculating an optimal route to the location of the client, transmitting a predicted arrival time and taxi information to allow the available taxi selected by the client to be identified, to the client, and confirming the intention of the client to use the available taxi; and
if the client transmits the approval signal to the central control office, the central control office transmitting a movement command signal to command the available taxi;
after the step of the central center transmitting the location information of the client to the available taxi selected by the client, and before the step of the available taxi moving to the location of the client.

16. The method according to claim 14, wherein traffic information displayed on a map provided by the central control office, or traffic information generated by the car navigation system installed in the available taxi and displayed on a map of the taxi, is displayed in conjunction with the location of the available taxi which moves to the location of the client, or accepts the client therein and moves to the destination of the client.
